(19) United States
(12) Patent Application Publication
(10) Pub. No.: US 2013/0241317 A1
(43) Pub. Date: Sep. 19, 2013

(54) SHORT-CIRCUITING DEVICE FOR A PHOTOVOLTAIC ARRAY

(71) Applicants: Franck Sarrus, Saint Laurent De Mure (FR); Thierry Rambaud, Genas (FR)

(72) Inventors: Franck Sarrus, Saint Laurent De Mure (FR); Thierry Rambaud, Genas (FR)

(73) Assignee: MERSEN FRANCE SB SAS, Saint-Bonnet-De-Mure (FR)

(21) Appl. No.: 13/820,245

(22) PCT Filed: Sep. 1, 2011
(86) PCT No.: PCT/FR2011/052005

§ 371 Date: May 31, 2013

(30) Foreign Application Priority Data
Sep. 1, 2010 (FR) 10 56926

(51) Int. Cl. H02H 5/12

(52) U.S. Cl. CPC H02H 5/12
USPC 307/326

(57) ABSTRACT

This short-circuiting device establishes and maintains a short-circuit across the terminals of a photovoltaic array having at least one photovoltaic panel. It comprises a member designed, on a given signal, to establish and maintain a short-circuit between two electrically conductive tracks each connected to a terminal of the photovoltaic panels of the photovoltaic array. The short-circuiting device furthermore comprises an indicator that the short circuit has been established and is being maintained, the means being mechanically activated by the member designed to establish and maintain the short-circuit. The indicator includes a warning light independent of the member and establishing and maintaining the short-circuit, and that can move, under the action of an elastic member, between a retracted position, in which it indicates that electrical power is being produced by the array, and a visible position, indicating that a short-circuit has been established and is maintained between the tracks.

### CROSS-REFERENCE TO RELATED APPLICATIONS

The present application is a National Stage of International Application No. PCT/FR2011/052005 filed Sep. 1, 2011, which published as WO 2012/089947 on Jul. 5, 2012. PCT '005 claims priority to French Application No. 10 56926 filed Sep. 1, 2010. All the above applications are herein incorporated by reference.

### FIELD OF INVENTION

The present invention relates to a short-circuiting device for a photovoltaic array designed to establish and maintain a short-circuit across the terminals of photovoltaic panels installed in the building.

### BACKGROUND

In the field of energy production by recovering solar radiation, it is common to install photovoltaic panels on the roofs of buildings, whether they are individual homes or professional buildings. The energy produced is either provided to the public grid, or used in the buildings themselves for various purposes.

During emergency or maintenance operations, it is necessary to stop energy production by the photovoltaic arrays so as to guarantee the physical integrity of the people performing those operations. Firefighters in particular must deactivate energy production before any intervention on fires.

From that perspective, it is known, for example from EP-A-1 720 241 to use means for interrupting the production of electrical current in particular using circuit breakers or short-circuiting devices, so as to guarantee that the building is secured. These means are generally activated from a predefined part of the building at the time of the operation.

Once this manipulation has been done, it is necessary for the operating personnel to be notified that the building has been secured. To that end, FR-A-2 940 548 provides indicators in particular implementing visual signals. However, these indicator means do not make it possible to be sure that the array is actually secured, since these means in particular operate using electronic detection and indicator members that may be subject to malfunctions, in particular in case of fire.

It is known from DE-A-20 2006 020 737 to equip a short-circuiting device with indicator means mechanically connected to the member performing the short-circuit, so as to show or hide a signal as a function of the movement of that member. However, the solution does not provide enough precision and reliability, in particular visual.

The invention aims to resolve these drawbacks by proposing a short-circuiting device for a photovoltaic array making it possible to indicate the actual performance of the short-circuit across the terminals of photovoltaic panels reliably and to prevent the indicator means from being activated in an untimely manner.

### SUMMARY

To that end, the invention relates to a short-circuiting device designed to establish and maintain a short-circuit across the terminals of a photovoltaic array comprising at least one photovoltaic panel, said short-circuiting device having a member designed, on a given signal, to establish and maintain a short-circuit between two electrically conductive tracks each connected to a terminal of the photovoltaic panels of the photovoltaic array, the short-circuiting device comprising a means for visually indicating that the short-circuit has been established and is being maintained. This short-circuiting device is characterized in that the indicator means is activated mechanically by the member designed to establish and maintain the short-circuit, and in that the visual indicating means comprises a warning light that is independent of the member designed to establish and maintain the short-circuit, and that can move, under the action of the elastic member, between a retracted position, in which it indicates that electrical power is being produced by the array, and a visible position, in which it indicates that a short-circuit has been established and is being maintained between the tracks.

Owing to the invention, the member that physically produces the short-circuit across the terminals of the photovoltaic panels itself activates the visual indicator indicating that the building has been secured. This activation is done mechanically, it does not depend on the operation of electronic components, and it does not risk being activated in an untimely manner, or being activated when the short-circuit has not actually been done.

According to other examples, such a short-circuiting device may incorporate one or more of the following features, considered in any technically allowable combination:

In the retracted position, the visual indicating means is completely housed inside an opaque box and, in the visible position, the visual indicating means extends at least partially outside the box.

The member designed to establish and maintain the short-circuit is a closing lever that is hinged relative to one of the conductive tracks and subjected to a force exerted by an elastic member, said force tending to move the closing lever toward a position, corresponding to the establishment of the short-circuit, in which the closing lever is in electrical contact with the two conductive tracks.

The warning light can be moved along an axis parallel to an axis of rotation of the closing lever toward its position corresponding to the establishment of the short-circuit.

The closing lever is kept in an open position, in which the array draws current normally, by a maintaining hook that is articulated relative to a bottom of the short-circuiting device.

The short-circuiting device includes an actuator designed to drive the maintaining hook into a position releasing the closing lever.

The actuator comprises a rod striking the maintaining hook, designed to move in translation toward the maintaining hook under the effect of a second actuator.

The second actuator is a pneumatic member.

The pneumatic member is a compressed gas cartridge.

Alternatively, the second actuator is a mechanical member that can be actuated by a person.

The warning light is kept in a position indicating the production of electricity by the photovoltaic array by a retaining lever designed to bearingly receive a stop of the indicating means.

The retaining lever can be moved toward a position in which the indicating means is released toward its position indicating the establishment and maintenance of the short-circuit through a mechanical action exerted by the member designed to establish and maintain the short-circuit.

The closing lever can strike the retaining lever when it is moved toward its position corresponding to the establishment of the short-circuit.

The retaining lever comprises a notch for receiving a portion of the indicating means and defines a bearing surface for the stop, around the notch.

### BRIEF DESCRIPTION OF THE DRAWINGS

The invention can be better understood, and other advantages thereof appear more clearly, in light of the following description of one embodiment of a short-circuiting device for a photovoltaic array according to its principle, provided solely as an example and done in reference to the appended drawings, in which:

FIG. 1 is a perspective view of a short-circuiting device according to an example of the invention;

FIG. 2 is a cross-section in plane II of the short-circuiting device of FIG. 1;

FIG. 3 is a cross-section similar to FIG. 2, in a short-circuit configuration done by the short-circuiting device;

FIG. 4 is a cross-section in plane IV of the short-circuiting device of FIG. 1, in the retracted configuration of a means for indicating the short-circuit belonging to the short-circuiting device according to the invention identical to that of FIG. 2;

FIG. 5 is a cross-section similar to FIG. 4, in the configuration of FIG. 3 where the indicating means is visible.

### DETAILED DESCRIPTION

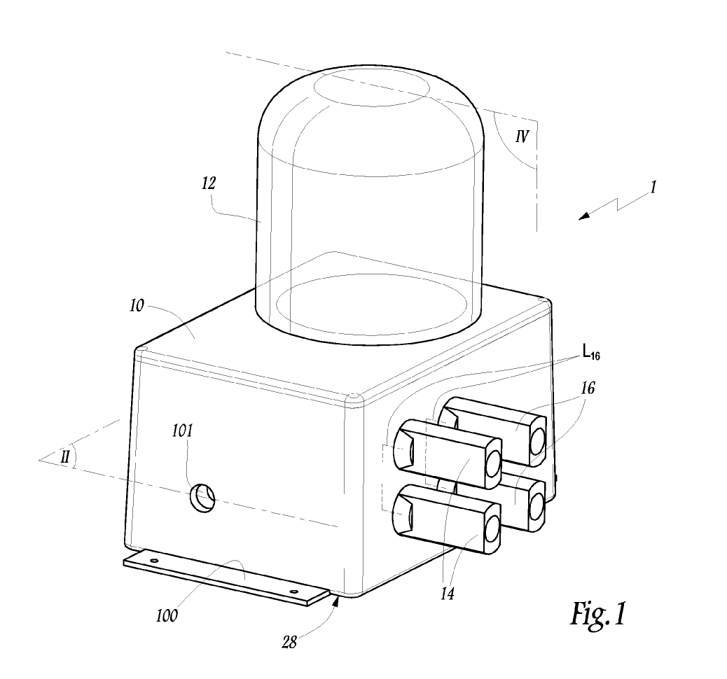

FIG. 1 shows a short-circuiting device 1 including a box 10 made from an opaque plastic material with a strong resistance to deterioration, in particular to fire, including a bottom 28 and an indicating dome 12 mounted on the box 10. The short-circuiting device 1 is designed to be inserted, in a building, between photovoltaic panels belonging to a photovoltaic array producing electricity from solar energy (not shown), and energy conversion and storage devices that make it possible to connect the photovoltaic array to the AC electrical grid. This photovoltaic array may include one or more photovoltaic panels connected to each other in a known manner.

The conversion device may be an inverter (not shown) making it possible to convert the DC current generated by the array into AC current that can be used in particular by household electrical devices. This inverter may incorporate an energy storage device of the capacitance type.

The short-circuiting device is inserted into the electrical circuit of the photovoltaic array by means of two terminals 14 connected to the positive polarities, and two terminals 16 connected to the negative polarities.

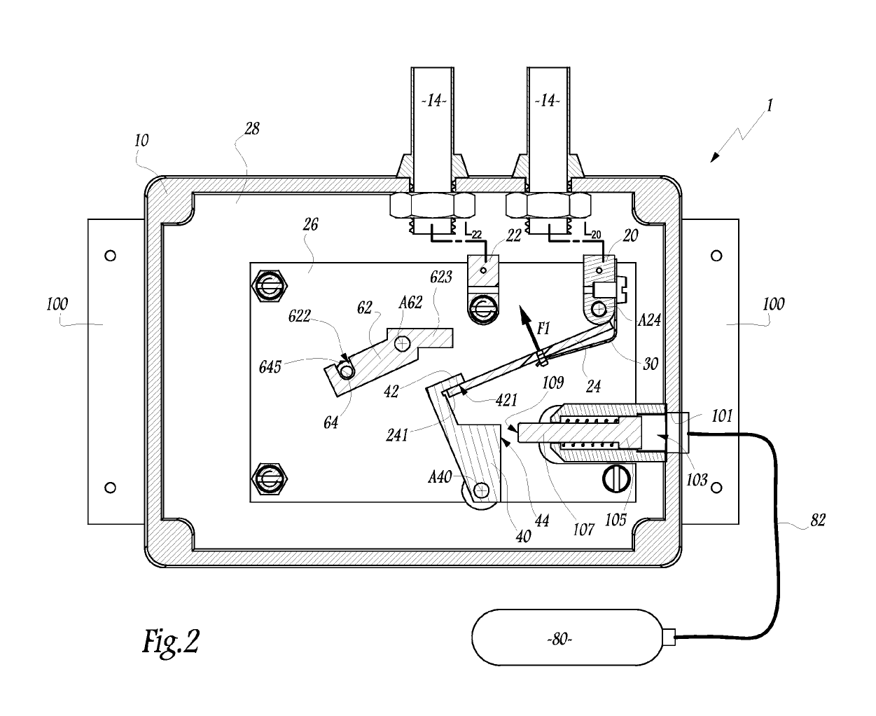

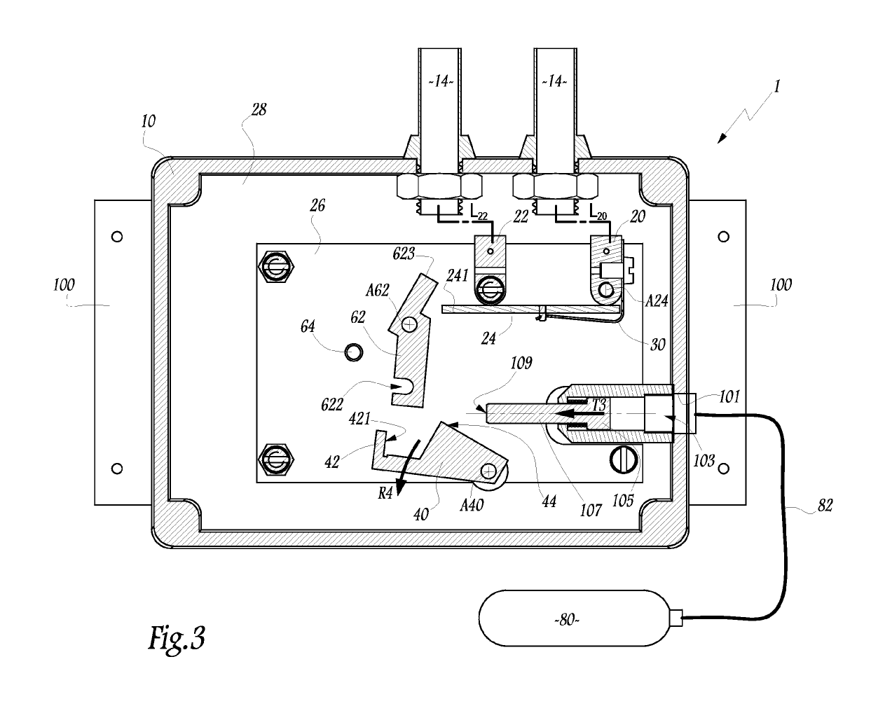

As shown in FIGS. 2 and 3, each of the terminals 14 is connected to a track 20 and 22 by an electrical line L₂₀ or L₂₂.

A closing lever 24 is articulated on the track 20 around an axis A24. The tracks 20 and 22 are parallel to each other and extend over a plate 26 fixed to the box 10 and parallel to the flat bottom 28 of that box. The bottom 28 defines a plane P28. The axis A24 is perpendicular to the plane P28 and the closing lever 24 is designed to pivot parallel to the plane P28.

The closing lever 24 is designed to create and maintain the short-circuit of the terminals of the photovoltaic array by establishing an electrical contact between the tracks 20 and 22, as emerges from FIG. 3. To that end, the closing lever 24 is made from an electrically conductive material.

A spring 30 exerts a force F1 on the closing lever 24 that tends to drive the closing lever 24 into a closed position, in which said lever 24 puts the tracks 20 and 22 in electrical contact, and establishes and maintains the short-circuit.

When the short-circuit is not required, the closing lever 24 is kept in an open position, shown in FIG. 2, in which to end 241 opposite the axis A24 is retained by a maintaining hook 40. In this configuration, the photovoltaic array draws current normally in the grid by means of the terminals 14 and 16, which are electrically connected to each other, by means of electrical lines L₁₆.

The maintaining hook 40 is articulated on the plate 26 around an axis A40 perpendicular to the plane P28. The hook 40 includes a tongue 42 making it possible to withstand the force F1, by opposing a bearing surface 421 to the end 241 of the lever 24.

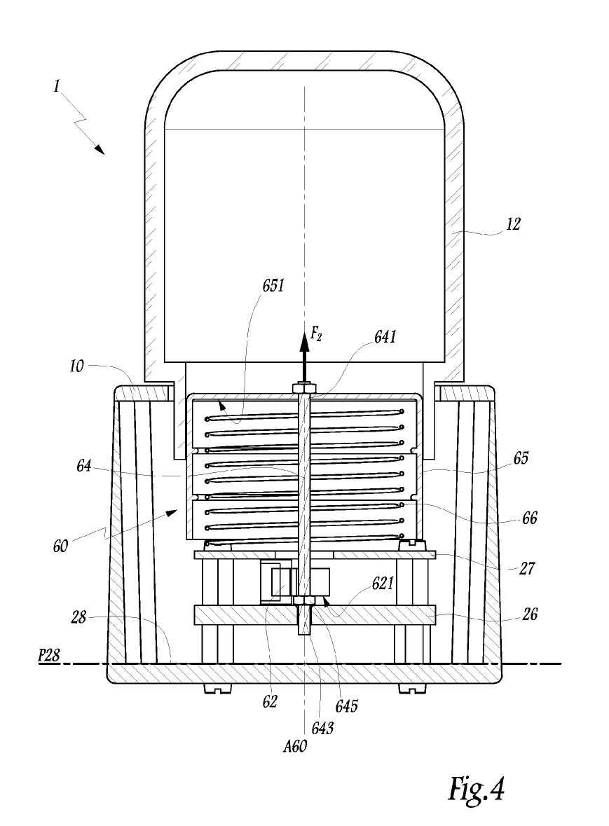

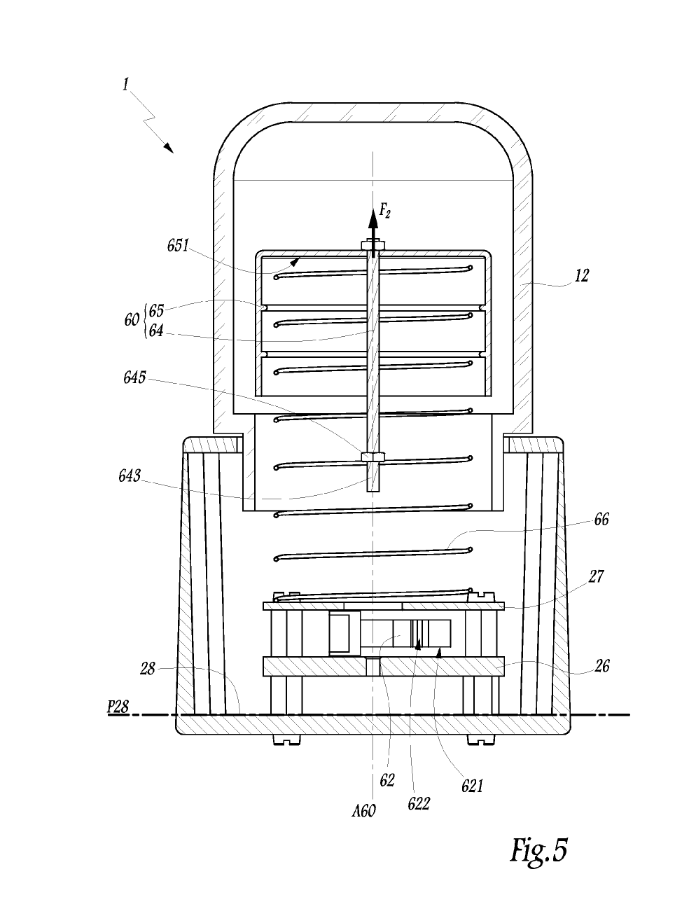

As shown in FIGS. 4 and 5, short-circuiting device 1 includes a means for indicating the establishment and maintenance of the short-circuit across the terminals of the photovoltaic array, which has a warning light 60, which is generally cylindrical, designed to be translated between a retracted position, shown in FIG. 4, in which the warning light 60 is completely housed in the box 10, and a visible position, shown in FIG. 5, in which the warning light 60 is located at the dome 12. In that configuration, the warning light 60 is visible to operating teams intending to enter the building, through the dome 12, which is transparent. The dome 12 may be made from glass or a material with strong resistance to deterioration.

The warning light 60 is kept in the retracted position in the housing 10 by a retaining lever 62, which is articulated on the plate 26 around an axis A62 perpendicular to the plane P28. The warning light 60 includes a rod 64 connected to a shell 65 of the warning lights 60 by an end 641. At its other end 643, the rod 64 includes a stop 645, formed by a nut and designed to bear against a surface 621 of the retaining lever 62 turned toward the bottom 28, while the end 643 is engaged in a notch 622 of that lever. The bearing between the stop 645 and the surface 621 around the notch 622 makes it possible to withstand a force F2 exerted by a spring 66 and which tends to drive the warning light 60 perpendicularly relative to the plane P28 toward the inside of the dome 12, in its visible position. The spring 66 is, in the retracted position of the warning light 60, compressed between a bottom surface 651 of the shell 65 and a plate 27 secured to the box 10, parallel to the plate 26 and arranged above the plate 26. The retaining lever 62 makes it possible to retain the warning light 60 in its retracted configuration when the short-circuiting of the array is not necessary.

In case of fire or another accident affecting the building supporting the photovoltaic array, the short-circuiting device is remotely controlled by means of a lever or emergency button striking a compressed gas cartridge 80. The gas cartridge 80 is connected to the short-circuiting device 1 by a metal tube 82 inserted into a port 101 of the box 10, which communicates with the chamber 103. A piston 105, translatable in the chamber 103 along an axis A105, is secured to a rod 107 that protrudes from the body 108 in which the chamber 103 is defined, toward the maintaining hook 40.

The short-circuiting device 1 may be triggered automatically in case of fire by the temperature destruction of the maintaining hook 40 or by a command sent to the cartridge 80 from a fire detector.

For clarity of the drawing, the cartridge 80 is not shown in FIG. 1.

When the short-circuit order is given, the compressed gas contained in the cartridge 80 is released in the chamber 103 and drives a translational movement T3 of the piston 105. This movement drives the striking of a surface 44 of the hook 40 by the end 109 of the rod 107 opposite the piston 105. This impact results in driving the hook 40 in a rotational movement R4 around the axis A40. This movement R4 makes it possible to release the closing lever 24 and the pivoting thereof under the effect of the force F1, making it possible to establish the short-circuit between the tracks 20 and 22, and therefore between the terminals 14.

When the closing lever 24 pivots, its end 241 strikes an extension 623 of the retaining lever 62, driving a rotational movement R5 of the lever 62 around the axis A62. This movement R5 results in extracting the end 643 of the rod 64 from the notch 622 and releasing the stop 645. Nothing then opposes the translation of the shell 65 under the effect of the force F2, and the warning light 60 is therefore driven toward the inside of the dome 12 in its visible position, making it possible to indicate the establishment and maintenance of the short-circuit across the terminals of the photovoltaic array and the securing of the building, before the operation by the emergency services.

The release of the warning light 60 is activated mechanically by the closing lever 24, which establishes the short-circuit between the tracks 20 and 22. In fact, the lever 24 acts on the lever 62, which releases the warning light 60 during its rotation R5. One can therefore be sure that the short-circuit is established when the warning light 60 comes to its visible position within the dome 12, inasmuch as the retaining lever 62 can only be set in motion by the closing lever 24.

The warning light 60 is movable along an axis A60 parallel to the axis of rotation A24 of the closing lever 24.

The system is reliable because it is the last moving part, i.e., the lever 24, that controls the activation of the warning light 60. The system therefore does not depend on the status of an intermediate part, such as the members 105 and 40, the malfunction of which would be able to activate the appearance of the warning lights 60 whereas the short-circuit is not actually established, and conversely, not signaling the short-circuit when it has been established. Furthermore, the fact that the closing lever 24, which performs the short-circuit, and the warning light 60 are independent parts improves the reliability of the short-circuiting device.

The gas cartridge 80 contains a gas such as carbon dioxide. This cartridge 80 is intended for a single use and must be replaced each time the short-circuit is activated and the short-circuiting device 1 is rearmed. It may be considered for the short-circuiting device 1 to include mechanical rearming means. Using a gas cartridge makes it possible to have a safe energy source for activating the short-circuit and makes it possible to avoid using electricity, which improves the reliability of the short-circuiting device 1.

Alternatively, it is possible to consider the translational movement of the rod 107 being initiated by other means such as pneumatic, hydraulic, mechanical or pyrotechnic actuators. In particular, the movement of the rod 107 can be obtained by a mechanical member, controlled by a maneuvering member such as a pole, which can be actuated directly by a person. It may also be considered for the transmission of forces and the activation of certain movements of the component parts of the system to be done by a cam system.

The warning light 60 is advantageously painted a color, for example red, yellow or orange, allowing it to be viewed clearly from an area remote from the building, such as a road down below. The warning light 60 can advantageously be covered with a reflective or fluorescent material so as to be able to be distinguished at night.

The box 10 of the short-circuiting device 1 includes fasteners 100 making it possible to fix it in a high-up outer area of the building, such as a façade or a roof, using any suitable means.

The short-circuiting device 1 is placed as close as possible to the photovoltaic panels, so that the electrical connections between the short-circuiting device 1 and the photovoltaic panels are as short as possible, which reduces the risk of opening of the electrical circuit following the destruction of cables due to the accident, for example in the event of collapse of the structures.

Depending on the electrical powers and the number of photovoltaic panels used in the array, the short-circuiting device 1 can comprise a larger number of terminals 14 and 16 and closing levers 24, and several short-circuiting devices 1 according to the invention may be provided.

1. A short-circuiting device designed to establish and maintain a short-circuit across the terminals of a photovoltaic array comprising at least one photovoltaic panel, said short-circuiting device comprising:
a member designed, on a given signal, to establish and maintain a short-circuit between two electrically conductive tracks each connected to a terminal of the photovoltaic panels of the photovoltaic array, the short-circuiting device comprising:
an indicator visually indicating that the short-circuit has been established and is being maintained,
wherein the indicator is activated mechanically by the member designed to establish and maintain the short-circuit, and
wherein indicator comprises a warning light that is independent of the member designed to establish and maintain the short-circuit, and that can move, under the action of an elastic member, between a retracted position, in which it indicates that electrical power is being produced by the array, and a visible position, in which it indicates that a short-circuit has been established and is being maintained between the tracks.

2. The short-circuiting device according to claim 1, wherein in the retracted position, the indicator is completely housed inside an opaque box and, in the visible position, the indicator extends at least partially outside the box.

3. The short-circuiting device according to claim 1, the member designed to establish and maintain the short-circuit is a closing lever that is hinged relative to one of the conductive tracks and subjected to a force exerted by an elastic member, said force tending to move the closing lever toward a position, corresponding to the establishment of the short-circuit, in which the closing lever is in electrical contact with the two conductive tracks.

4. The short-circuiting device according to claim 3, characterized in that the warning light can be moved along an axis parallel to an axis of rotation of the closing lever toward its position corresponding to the establishment of the short-circuit.

5. The short-circuiting device according to claim 3, wherein the closing lever is kept in an open position, in which the array draws current normally, by a maintaining hook that is articulated relative to a bottom of the short-circuiting device.

6. The short-circuiting device according to claim 5, wherein it includes an actuator designed to drive the maintaining hook into a position releasing the closing lever.

7. The short-circuiting device according to claim 6, wherein the actuator comprises a rod striking the maintaining hook, designed to move in translation toward the maintaining hook under the effect of a second actuator.

8. The short-circuiting device according to claim 7, wherein the second actuator is a pneumatic member.

9. The short-circuiting device according to claim 8, wherein the pneumatic member is a compressed gas cartridge.

10. The short-circuiting device according to claim 7, wherein the second actuator is a mechanical member that can be actuated by a person.

11. The short-circuiting device according to claim 1, wherein the indicator is kept in a position indicating the production of electricity by the photovoltaic array by a retaining lever designed to bearingly receive a stop of the indicator.

12. The short-circuiting device according to claim 11, wherein the retaining lever can be moved toward a position in which the indicator is released toward its position indicating the establishment and maintenance of the short-circuit through a mechanical action exerted by the member designed to establish and maintain the short-circuit.

13. The short-circuiting device according to claim 3, wherein the closing lever can strike the retaining lever when it is moved toward its position corresponding to the establishment of the short-circuit.

14. The short-circuiting device according to claim 10, wherein the retaining lever comprises a notch for receiving a portion of the indicator and defines a bearing surface for the stop, around the notch.
